(19) United States
(12) Patent Application Publication
(10) Pub. No.: US 2023/0125674 A1
(43) Pub. Date: Apr. 27, 2023

(54) SYSTEMS AND METHODS FOR ADVANCED SEISMIC SENSORS

(71) Applicant: MANDALA INDUSTRIES, LLC, Dover, DE (US)

(72) Inventor: Guillermo Bauer, Buenos Aires (AR)

(21) Appl. No.: 17/512,356

(22) Filed: Oct. 27, 2021

(51) Int. Cl. G01V 1/24; G01V 1/18; G01V 1/28

(52) U.S. Cl. CPC G01V 1/247; G01V 1/18; G01V 1/288

(57) ABSTRACT

A system is provided. The system includes a plurality of seismic sensors and a computer device. The computer device is programmed to a) store a plurality of distances between each of the plurality of seismic sensors; b) store one or more fingerprints of a signal to be detected; c) receive a first signal transmitted from a first seismic sensor of the plurality of seismic sensors; d) receive the first signal transmitted from a second seismic sensor of the plurality of seismic sensors; e) compare the first signal to the one or more fingerprints of the signal to be detected; and f) determine a direction of travel of the first signal based on the distance between the first seismic sensor and the second seismic sensor, the first time, and the second time.

### BACKGROUND

The field of the present disclosure relates generally to seismic sensors and, more specifically, to the placement and monitoring of seismic sensors for precise detection of low frequency signals.

Any given object has a natural frequency, where the object resonates or vibrates at its highest amplitude. Seismic sensors are capable of detecting multiple phenomena due to pressure waves and signals at different frequencies, where the signals are transmitted through different materials in the earth from the point of origin to the location of the sensor. However, for many different phenomena the frequencies are difficult to detect and may require precise monitoring of specific frequencies or ranges of frequencies. Furthermore, these frequencies or range of frequencies may change depending on the phenomena to be detected. Accordingly, it would be desirable to have a precise sensor system that can be used to detect these phenomena.

### BRIEF DESCRIPTION

In one aspect, a system is provided. The system includes a plurality of seismic sensors and a computer device. The computer device includes at least one processor in communication with at least one memory device. The computer device is further in communication with the plurality of seismic sensors. The at least one processor is programmed to store a plurality of distances between each of the plurality of seismic sensors. The at least one processor is also programmed to store one or more fingerprints of a signal to be detected. The at least one processor is further programmed to receive a first signal transmitted from a first seismic sensor of the plurality of seismic sensors. The first signal was observed by the first seismic sensor at a first time. In addition, the at least one processor is programmed to receive the first signal transmitted from a second seismic sensor of the plurality of seismic sensors. The first signal was observed by the second seismic sensor at a second time. Moreover, the at least one signal is programmed to compare the first signal to the one or more fingerprints of the signal to be detected. Furthermore, the at least one signal is programmed to determine a direction of travel of the first signal based on the distance between the first seismic sensor and the second seismic sensor, the first time, and the second time.

In another aspect, a system is provided. The system includes a plurality of islands. Each island of the plurality of islands includes a plurality of seismic sensors and an island computer device. The island computer device is in communication with the plurality of seismic sensors associated within the island. The system also includes a computer device including at least one processor in communication with at least one memory device. The computer device is further in communication with the plurality of island computer devices. The at least one processor is programmed to receive from a first island computer device of the plurality of island computer devices a first direction of travel of a first signal detected by the plurality of seismic sensors of a first island of the plurality of islands. The at least one processor is also programmed to receive from a second island computer device of the plurality of island computer devices a second direction of travel of a second signal detected by the plurality of seismic sensors of a second island of the plurality of islands. The at least one processor is further programmed to determine a source location of the first signal based on the first direction of travel and the second direction of travel. In addition, the at least one processor is programmed to report the source location to a remote computer device.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawing's arrangements, which are presently discussed, it being understood, however, that the present embodiments are not limited to the precise arrangements and instrumentalities shown, wherein:

FIG. 1 illustrates a block diagram of a system for using precision seismic sensors, in accordance with one embodiment of the present disclosure.

FIG. 2 illustrates a first configuration of an island of precision seismic sensors for use with the system shown in FIG. 1.

FIG. 3 illustrates a second configuration of an island of precision seismic sensors for use with the system shown in FIG. 1.

FIG. 4 illustrates a third configuration of an island of precision seismic sensors for use with the system shown in FIG. 1.

FIG. 5 illustrates a block diagram of an exemplary computer system for use with the system.

FIG. 6 illustrates a block diagram of an island of precision sensors detecting one or more signals from a phenomena, in accordance with one embodiment of the present disclosure.

FIG. 7 illustrates a block diagram of a plurality of islands of precision sensors detecting one or more signals from a phenomena, in accordance with one embodiment of the present disclosure.

FIG. 8 illustrates an example configuration of a user computer device used in the system shown in FIG. 1, in accordance with one example of the present disclosure.

FIG. 9 illustrates an example configuration of a server computer device used in the system shown in FIG. 1, in accordance with one example of the present disclosure.

### DETAILED DESCRIPTION

The implementations described herein relate to seismic sensors and, more specifically, to systems for seismic sensors for precise detection of low frequency signals. More specifically, a phenomena detecting (“PD”) computer device is provided for monitoring the precise seismic sensors and detecting one or more phenomena.

The systems and methods in this disclosure describe a phenomena detecting system that uses precise seismic sensors to detect various frequencies underground that indicate the occurrence of different phenomena, including both man-made and natural phenomena. Example phenomena that can be monitored for include, but are not limited to, underground construction, fracking, cave and mine collapse, volcanos, earthquakes, underground nuclear testing, underground digging, underwater movement, building movement and settling, and/or tsunamis.

In this disclosure, a plurality of precise seismic sensors are attuned to a specific phenomenon and are then monitored to detect the occurrence of one or more frequencies that would indicate the occurrence of the specific phenomena. The precise seismic sensors can be attuned to detect phenomena, signals, electromagnetic pulses, pressure waves, sound frequencies, and/or vibration. In the exemplary embodiment, the precise seismic sensors transmit detected signals/frequencies to a connected PD computer device. In some embodiments, the PD computer device transmits samples or portions of the detected signal. The PD computer device analyzes the detected signals/frequencies to determine if there is a match for a fingerprint of the detected phenomena. If the phenomena is detected, the PD computer device can store the information for later use and/or transmit one or more alerts to one or more user devices.

Described herein are computer systems such as the PD computer devices and related computer systems. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers; reduced instruction set circuits (RISC), application-specific integrated circuits (ASICs), logic circuits, and any other circuit or processor capable of executing the functions described herein. The above examples are example only and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In another embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). In still yet a further embodiment, the system is run on Android® OS (Android is a registered trademark of Google, Inc. of Mountain View, Calif.). In another embodiment, the system is run on Linux® OS (Linux is a registered trademark of Linus Torvalds of Boston, Mass.). The application is flexible and designed to run in various different environments without compromising any major functionality.

The application is flexible and designed to run in various different environments without compromising any major functionality. In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

As used herein, the term “low frequencies” refers to frequencies under 100 Hz, especially inaudible frequencies, such as those under 25 Hz.

The systems and processes are not limited to the specific embodiments described herein. In addition, components of each system and each process can be practiced independent and separate from other components and processes described herein. Each component and process also can be used in combination with other assembly packages and processes.

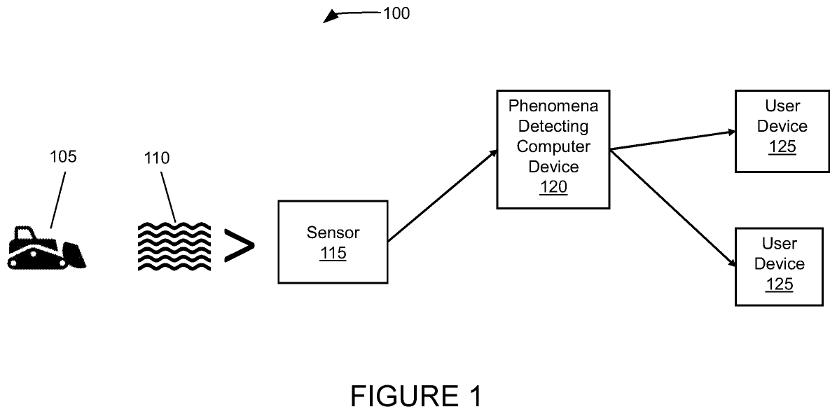

FIG. 1 illustrates a block diagram of a system 100 for using precision seismic sensors 115, in accordance with one embodiment of the present disclosure. In the exemplary embodiment, system 100 is configured to detect one or more phenomena 105 that causes resonance.

For the purpose of this disclosure the phenomena 105 can be either man-made or natural phenomena 105. Examples of phenomena 105 that can be monitored by the system 100 include, but are not limited to, underground construction, fracking, cave and mine strain and/or collapse, volcanos, earthquakes, underground nuclear testing, underground digging, underwater movement, building movement and settling, and/or tsunamis.

The phenomena 105 create signals 110 that travel through the ground and can be detected by precise seismic sensors 115. The signals 110 can include, but are not limited to, electromagnetic pulses, pressure waves, traveling waves, vibrations, sound frequencies, and/or other frequencies. The precise seismic sensors 115 can be attuned to detect phenomena 105. In the exemplary embodiment, the precise seismic sensors 115 are configured to detect a narrow range of frequencies to precisely detect the signals 110 indicative of the occurrence of one or more phenomena 105. The correlation between signals 110 and phenomena 105 can be detected and/or determined through analysis of historical signals 110 detected before, after, and/or during the occurrence of phenomena similar to the one to be detected.

The sensors 115 detect the signals 110 from phenomena 105 and transmit the detection to one or more phenomena detecting (“PD”) computer device 120. In some embodiments, the sensor 115 transmits an indication that the signal 110 has been detected. In other embodiments, the sensor 115 transmits the detected signals 110 for the PD computer device 120 to analyze. In some of these embodiments, the precise seismic sensor 115 is constantly transmitting signals 110 to the PD computer device 120 to analyze.

In some embodiments, the PD computer device 120 is a single computer device. In other embodiments, the PD computer device 120 includes a plurality of computer devices in communication over a network, such as the Internet. In the example embodiment, the PD computer device 120 include a web browser or a software application, which enables the PD computer device 120 to communicate with sensors 115 and one or more user devices 125 using the Internet, a local area network (LAN), or a wide area network (WAN). In some examples, the PD computer device 120 is communicatively coupled to the Internet through many interfaces including, but not limited to, at least one of a network, such as the Internet, a LAN, a WAN, an integrated services digital network (ISDN), a dial-up-connection, a digital subscriber line (DSL), a cellular phone connection, a satellite connection, and/or a cable modem. PD computer devices 120 can be any device capable of accessing a network, such as the Internet, including, but not limited to, a desktop computer, a laptop computer, a personal digital assistant (PDA), a cellular phone, a smartphone, a tablet, a phablet, or other web-based connectable equipment. In some of these embodiments, there can be a PD computer device 120 at each sensor 115 location, which is then in communication with one or more central or controlling PD computer devices 120.

The PD computer device 120 is further in communication with one or more user devices 125. In the exemplary embodiment, the PD computer device 120 transmits one or more notifications to the one or more user devices 125 when a signal 110 indicative of a phenomena 105 is detected. In the example embodiment, the user devices 125 include a web browser or a software application, which enables the user devices 125 to communicate with the PD computer device 120 using the Internet, a local area network (LAN), or a wide area network (WAN). In some examples, the user devices 125 are communicatively coupled to the Internet through many interfaces including, but not limited to, at least one of a network, such as the Internet, a LAN, a WAN, an integrated services digital network (ISDN), a dial-up-connection, a digital subscriber line (DSL), a cellular phone connection, a satellite connection, and/or a cable modem. User devices 125 can be any device capable of accessing a network, such as the Internet, including, but not limited to, a desktop computer, a laptop computer, a personal digital assistant (PDA), a cellular phone, a smartphone, a tablet, a phablet, or other web-based connectable equipment.

In the exemplary embodiment, when a phenomena 105 occurs, the phenomena 105 causes signals 110 to be transmitted through the Earth or ground. For example, if an earth moving device is being used to dig a hole, then the earth moving device causes vibrations that resonate with the ground surrounding the earth moving device. These vibrations travel through the ground. If attuned to the proper frequencies, as described herein, the precise seismic sensors 115 detect the vibrations.

When the signals 110 from the phenomena 105 reach the sensor 115, the sensor 115 detects the signals 110, which are then transmitted to the PD computer device 120. The PD computer device 120 analyzes the received signals 110 to detect the signal 110 indicative of the phenomena 105. In the exemplary embodiment, the PD computer device 120 filters the received signals 110 to detect the desired signals. In these embodiments, the PD computer device 120 processes the received signals to remove noise and detect the contained frequencies. Then the PD computer device 120 compares the filtered signals 110 to known versions of the signal 110 to determine if the desired signal is present. In some further embodiments, the PD computer device 120 filters the received signals 110 through a bandpass filter to remove unneeded frequencies and noise. In some embodiments, the PD computer device 120 uses fingerprint analysis to detect the appropriate signal 110. In these embodiments, the PD computer device 120 determines if the desired signals 110 are present. If the desired signals 110 are present, the PD computer device 120 can transmit one or more notifications to the user devices 125. For example, if the phenomena 105 is a man-made, such as an earth moving device working underground, the PD computer device 120 can transmit a report with the notification describing when and where the phenomena 105 is occurring to the user devices 125. In another example, if the phenomena 105 is natural, such as a volcano or earthquake, the PD computer device 120 can transmit alerts to user devices 125 for those users to get to safety.

In the exemplary embodiment, the system 100 includes a plurality of sensors 115 at a plurality of locations, wherein at least a portion of the plurality of sensors 115 detects the signals 110. Based on the different locations of the sensors 115, the sensors 115 detect the signals 110 at different times. By comparing the different times that the various sensors 115 detect the signals 110, the PD computer device 120 is capable of determining the location of the phenomena 105 that originated the signals 110.

In the exemplary embodiment, the PD computer device 120 is trained to recognize the desired signals. In some embodiments, this training includes machine learning, where the PD computer device 120 receives a plurality of historical and simulated signals as a training set. The PD computer device 120 uses machine learning to build one or more models based on the training set. The model allows the PD computer device 120 to efficiently and accurately detect the desired signals.

In the exemplary embodiment, the sensors 115 include a precision clock, such as a GPS (global positioning system) clock or atomic clock to accurately track time. This allows the system 100 to accurately and precisely determine when the signals 110 were detected by the sensors 115. The sensors 115 are capable of communicating with the PD computer device 120 using the Internet, a local area network (LAN), or a wide area network (WAN). In some examples, the sensors 115 are communicatively coupled to the Internet through many interfaces including, but not limited to, at least one of a network, such as the Internet, a LAN, a WAN, an integrated services digital network (ISDN), a dial-up-connection, a digital subscriber line (DSL), a cellular phone connection, a satellite connection, and/or a cable modem.

The PD computer device 120 is capable of performing the analysis of the signals 110 in a plurality of different manners. In a first example, the PD computer device 120 is capable of performing statistical analysis on the signals 110. In this example, the PD computer device 120 organizes the signal information into four cases, True Positive, True Negative, False Positive (Type I error), and False Negative (Type II error). The PD computer device 120 defines an allowable gap error between the ends of low possibilities for matching signals 110. An error of just a few seconds could result in a serious mistake in the analysis' efficiency. The PD computer device 120 calculates a confusion matrix (also known as a contingency table). The confusion matrix (or contingency matrix) considers a group with P positive instances and N negative instances of some condition (such as detecting the desired signal 110). The PD computer device 120 formulates the four outcomes into a 2×2 contingency table or confusion matrix.

In a second example, the PD computer device 120 uses a real numbers method to detect the desired signals 110. Assuming x and y are real function values known as Upper [x(t−z)] and Lower [y(z)]. The PD computer device 120 performs correlation simple analysis based on one or more predetermined equations.

In a third example, the PD computer device 120 uses a graphical analysis method to detect the desired signals 110. The graphical analysis method can be performed in at least two methodologies. The first method uses a polar diagram. The second method uses a Cartesian diagram. In the polar diagram method, the signal before calculation and the signal after calculation are compared to the angle from North. The angle from north indicates the angle between the phenomena center and the sensor 115 location with respect to North. The polar diagram method also considers the time between the signal 110 being received and the calculation being performed. In the Cartesian method, the geographic angle from the sensor 115 is not represented. The magnitude of the signal 110 represents the magnitude of the phenomena 105. This is represented on the Cartesian map with a direct correlation between magnitude and dot size.

In some embodiments, the PD computer device 120 performs one or more or all of the above analyses on the received signals 110 to detect the desired signals.

In some embodiments, the PD computer device 120 is in communication with one or more databases (not shown). The database is a database that includes a plurality of signal classifications, a plurality of signal information, a plurality of historical signals, a plurality of signal fingerprints, and/or additional information. In some examples, the database is stored remotely from the PD computer device 120. In further examples, the database is decentralized. In at least one example, a person can access the database via the user device 125 by logging onto the PD computer device 120.

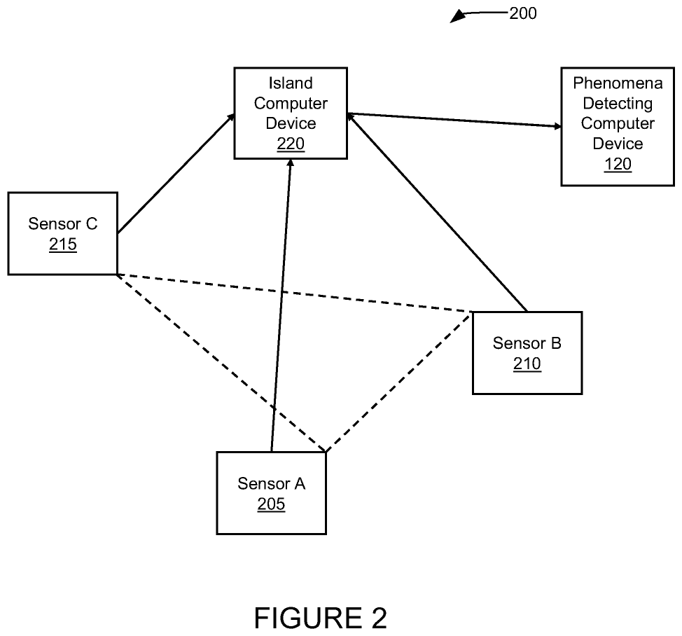

FIG. 2 illustrates a first configuration of an island 200 of precision seismic sensors 115 for use with the system 100 (both shown in FIG. 1). In the exemplary embodiment, an island 200 consists of three precision sensors 115 in communication with the PD computer device 120. FIGS. 2, 3, and 4 illustrate three different configurations of islands 200, 300, & 400, respectively.

FIG. 2 illustrates three sensors 115, sensor A 205, sensor B 210, and sensor C 215. Each sensor 205, 210, and 215 is positioned a distance away from each other. In some embodiments, the sensors 205, 210, and 215 are positioned between 100 and 200 meters from each other. However, in some embodiments, the sensors 205, 210, and 215 are positioned up to one kilometer from each other. In the exemplary embodiment, the sensors 205, 210, and 215 are buried underground for protection and to improve their ability to detect signals 110 from seismic phenomena 105 (both shown in FIG. 1).

In the exemplary embodiment, the three sensors 205, 210, and 215 are in communication with an island computer device 220. The three sensors 205, 210, and 215 transmit sensor readings to the island computer device 220. In island 200 shown in FIG. 2, the three sensors 205, 210, and 215 are connected to the island computer device 220 by either wired or wireless communications. The island computer device 220 is in either wired or wireless communication with at least one PD computer device 120. The island computer device 220 can be in communication with the phenomena detecting computer device 120 through a wired or wireless connection depending on the distance between the two devices. In some embodiments, the island computer device 220 analyzes the sensor information from the sensors 205, 210, and 215 to determine if a seismic phenomenon 105 has been detected. In other embodiments, the island computer device 220 modifies the sensor information, such as filtering the sensor information, such as with a bandpass filter, to reduce the amount of information being provided to the PD computer device 120. In still further embodiments, the island computer device 220 labels and transmits the sensor information to the PD computer device 120.

In the exemplary embodiment, the island computer device 220 transmits one or more notifications to the PD computer device 120 when a signal 110 indicative of a phenomena 105 is detected. In other embodiments, the island computer device 220 transmits raw or filtered sensor data from the sensors 205, 210, and 215 to the PD computer device 120. In the example embodiment, the island computer device 220 include a web browser or a software application, which enables the island computer device 220 to communicate with the PD computer device 120 using the Internet, a local area network (LAN), or a wide area network (WAN). In some examples, the island computer device 220 are communicatively coupled to the Internet through many interfaces including, but not limited to, at least one of a network, such as the Internet, a LAN, a WAN, an integrated services digital network (ISDN), a dial-up-connection, a digital subscriber line (DSL), a cellular phone connection, a satellite connection, and/or a cable modem. Island computer device 220 can be any device capable of accessing a network, such as the Internet, including, but not limited to, a desktop computer, a laptop computer, a personal digital assistant (PDA), a cellular phone, a smartphone, a tablet, a phablet, or other web-based connectable equipment.

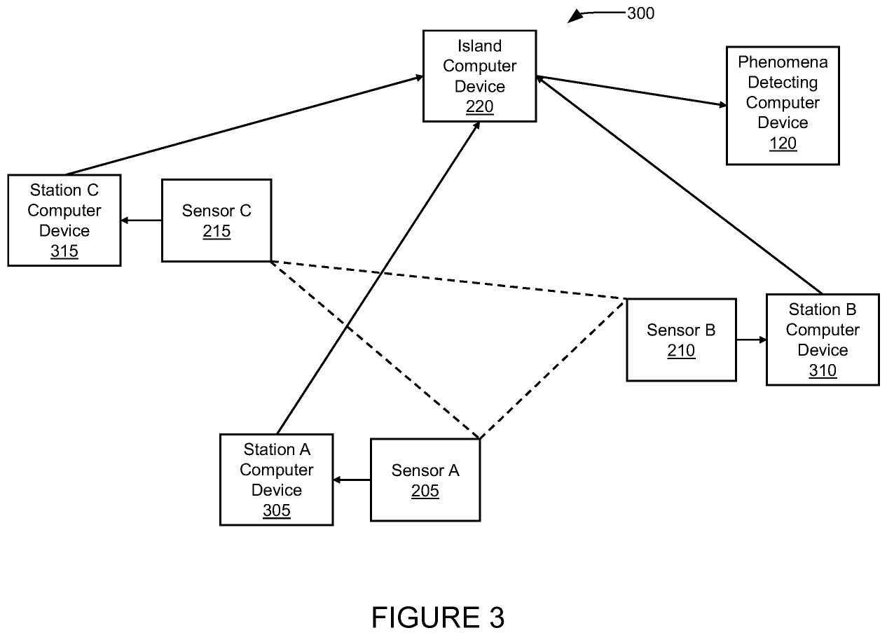

FIG. 3 illustrates a second configuration of an island 300 of precision seismic sensors 115 for use with the system 100 (shown in FIG. 1). Island 300 is a configuration where the three sensors 205, 210, and 215 are very distant from each other, for example, but not limited to, one kilometer. In this island 300, each sensor 205, 210, and 215 is supported by a station computer device 305, 310, and 315. The station computer devices 305, 310, and 315 facilitate communication between the sensors 205, 210, and 215 and the island computer device 220. In the island 300 shown in FIG. 3, the three sensors 205, 210, and 215 are connected to their corresponding station computer device 305, 310, and 315 via either wired or wireless communications. The station computer devices 305, 310, and 315 are in either wired or wireless communication with the island computer device 220. The station computer devices 305, 310, and 315 facilitate communication between the sensors 205, 210, and 215 and the island computer device 220. In some embodiments, the station computer devices 305, 310, and 315 transmit the raw sensor data to the island computer device 220. In other embodiments, the station computer devices 305, 310, and 315 analyze the sensor data and transmit the analysis to the island computer device 220. In still further embodiments, the station computer devices 305, 310, and 315 filter the sensor data, such as through a bandpass filter, prior to transmitting to the island computer device 220. In some further embodiments, the station computer devices 305, 310, and 315 are in direct communication with the PD computer device 120.

In the exemplary embodiment, the station computer devices 305, 310, and 315 transmit one or more notifications to the island computer device 220 when a signal 110 indicative of a phenomena 105 is detected. In the example embodiment, the station computer devices 305, 310, and 315 include a web browser or a software application, which enables the station computer devices 305, 310, and 315 to communicate with the island computer device 220 using the Internet, a local area network (LAN), or a wide area network (WAN). In some examples, the station computer devices 305, 310, and 315 are communicatively coupled to the Internet through many interfaces including, but not limited to, at least one of a network, such as the Internet, a LAN, a WAN, an integrated services digital network (ISDN), a dial-up-connection, a digital subscriber line (DSL), a cellular phone connection, a satellite connection, and/or a cable modem. The station computer devices 305, 310, and 315 can be any device capable of accessing a network, such as the Internet, including, but not limited to, a desktop computer, a laptop computer, a personal digital assistant (PDA), a cellular phone, a smartphone, a tablet, a phablet, or other web-based connectable equipment.

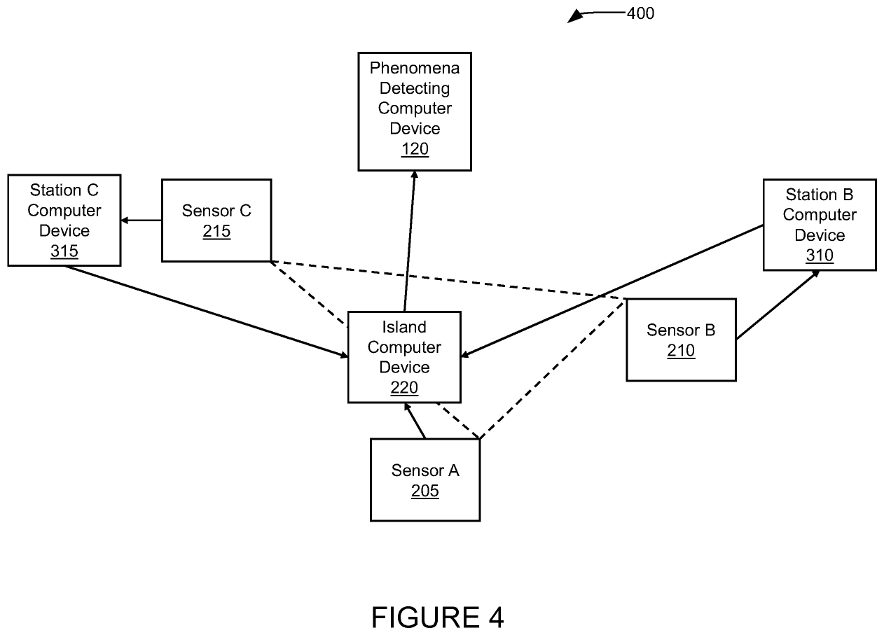

FIG. 4 illustrates a third configuration of an island 400 of precision seismic sensors 115 for use with the system 100 (shown in FIG. 1). In island 400, the island computer device 220 acts as a station computer device 310. In this configuration, the island computer device 220 collects sensor information from sensor A 205 directly and from sensors B 210 and C 215 through their corresponding station computer devices 310 and 315, respectively.

While the islands 200, 300, and 400 shown in FIGS. 2, 3, and 4, respectively, each include three sensors 205, 210, and 215, ones having skill in the art that more sensors 115 may be used in each island based on need. For example, one set of sensors 115 could be used to detect a specific range of frequencies associated with a first type of phenomena, while a second set of sensors 115 could be used to detect a different range of frequencies. In other embodiments, more sensors 115 may be used in each island 200, 300, or 400 to increase accuracy.

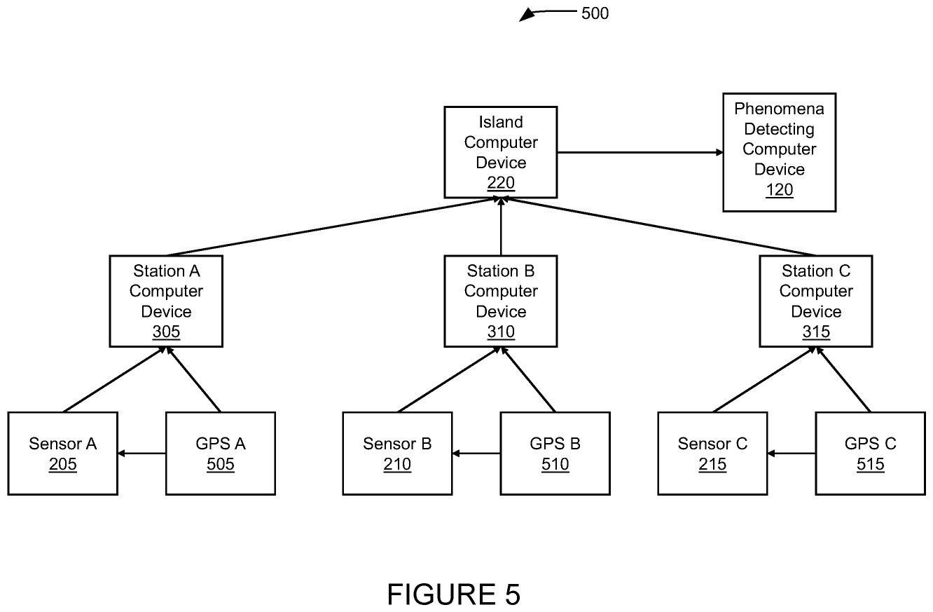

FIG. 5 illustrates a block diagram of an exemplary computer system 500 for use with the system 100 (shown in FIG. 1). In the exemplary embodiment, system 500 may be used for detecting seismic phenomena 105 based on received signals 110 (both shown in FIG. 1). As described below in more detail, the phenomena detecting computer device 120, can be configured to: (1) receive from a first island computer device 220 (shown in FIG. 2) of the plurality of island computer devices 220 a first direction of travel of a first signal 110 (shown in FIG. 1) detected by the plurality of seismic sensors 115 (shown in FIG. 1) of a first island 200 (shown in FIG. 2) of the plurality of islands 200, (2) receive from a second island computer device 220 of the plurality of island computer devices 220 a second direction of travel of a second signal 110 detected by the plurality of seismic sensors 115 of a second island 200 of the plurality of islands 200, (3) determine a source location of the first signal 110 based on the first direction of travel and the second direction of travel, and (4) report the source location to a remote computer device 125 (shown in FIG. 1).

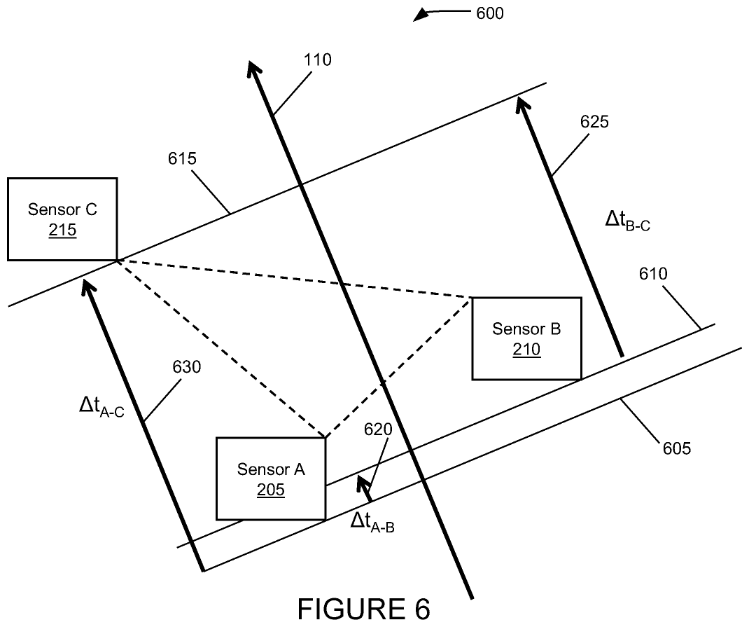

As described below in more detail, the island computer device 220, may be configured to: (1) store a plurality of distances between each of the plurality of seismic sensors 115, (2) store one or more fingerprints of a signal 110 to be detected, (3) receive a first signal 110 transmitted from a first seismic sensor 205 (shown in FIG. 2) of the plurality of seismic sensors 115, where the first signal 110 was observed by the first seismic sensor 205 at a first time 605 (shown in FIG. 6), (4) receive the first signal 110 transmitted from a second seismic sensor 210 (shown in FIG. 2) of the plurality of seismic sensors 115, where the first signal 110 was observed by the second seismic sensor 210 at a second time 610 (shown in FIG. 6), compare the first signal 110 to the one or more fingerprints of the signal 110 to be detected, and (5) determine a direction of travel of the first signal 110 based on the distance between the first seismic sensor 205 and the second seismic sensor 210, the first time 605, and the second time 610.

In the exemplary embodiments, the sensors 205, 210, and 215 are each paired with a global positioning system (GPS) device 505, 510, and 515. Each GPS device 505, 510, and 515 is configured to provide exact location information about the corresponding sensor 205, 210, and 215. Furthermore, GPS devices 505, 510, and 515 also each includes a precise clock to provide exact time for the sensor information. The exact time that each signal 110 reaches a sensor 205, 210, and 215 assists the island computer device 220 and/or the PD computer device 120 in determining when the directional vector of the signal 110 based on that timing information and the distances between the sensors 205, 210, and 215. In some embodiments, the GPS device 505, 510, and 515 is in communication with its the corresponding sensor 205, 210, and 215. In other embodiment, the GPS device 505, 510, and 515 is in communication with the corresponding station computer device 305, 310, and 315. The GPS devices 505, 510, and 515 may be integrated with any of the above island configurations 200, 300, and 400 (shown in FIGS. 2, 3, and 4).

FIG. 6 illustrates a block diagram of an island 600 of precision sensors 115 (shown in FIG. 1) detecting one or more signals 110 (shown in FIG. 1) from a phenomena 105 (shown in FIG. 1), in accordance with one embodiment of the present disclosure. In FIG. 6, a signal 110 travels through the island 600 of sensors 205, 210, and 215. The signal 110 reaches sensor A 205 first, then sensor B 210, and finally sensor C 215. For the purposes of this discussion, the signal reaches sensor A 205 at time A 605, sensor B 210 at time B 610, and sensor C 215 at time C 615.

Each one of the sensors 205, 210, and 215 detects the signal 110 and reports the signal 110 and when the signal 110 was detected. Then the island computer device 220 (shown in FIG. 2) and/or the PD computer device 120 (shown in FIG. 1) determines when the signal 110 reached each of the sensors 205, 210, and 215. The island computer device 220 and/or the PD computer device 120 determines the vector that the signal was traveling based on a difference 620 in time between reaching sensor A 205 (time A 605) and sensor B 210 (time B 610), a difference 625 in time between reaching sensor B 210 (time B 610) and sensor C 215 (time C 615), and a difference 630 in time between reaching sensor A 205 (time A 605) and sensor C 215 (time C 615). Since the exact locations and distances between each sensor 205, 210, and 215 and the exact times 605, 610, and 615 are known, the island computer device 220 and/or the PD computer device 120 can determine the direction of travel of the signal 110.

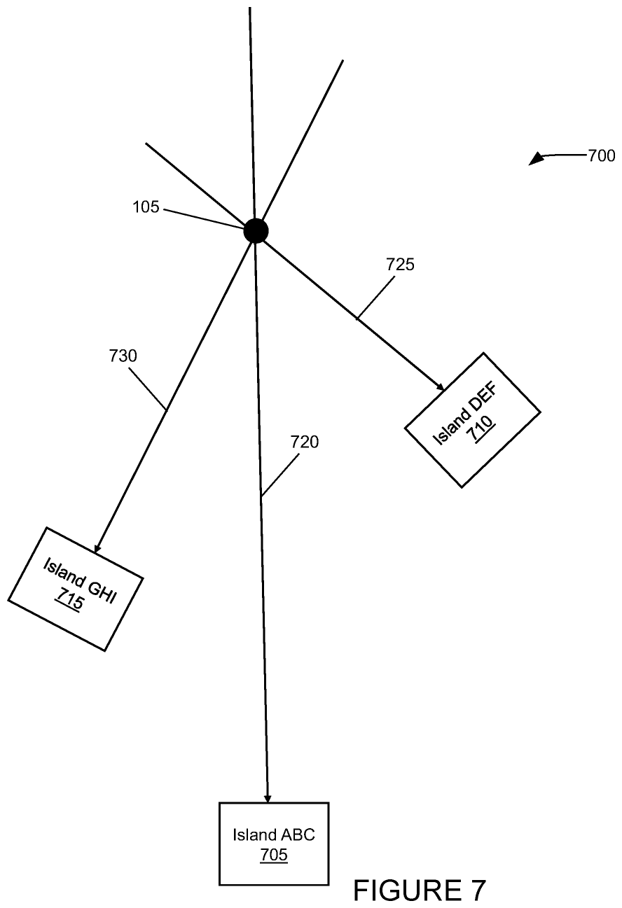

FIG. 7 illustrates a block diagram of a plurality of islands 600 (shown in FIG. 6) of precision sensors 115 (shown in FIG. 1) detecting one or more signals 110 (shown in FIG. 1) from a phenomena 105 (shown in FIG. 1), in accordance with one embodiment of the present disclosure. In FIG. 7, three islands 600, island ABC 705, island DEF 710, and island GHI 715, each detect a signal 110 (shown in FIG. 1) from a phenomena 105. For each island 705, 710, and 715, a vector 720, 725, and 730 is calculated to determine the direction of the signal 110 at each of the islands 705, 710, and 715. The vectors 720, 725, and 730 can be calculated by the corresponding island computer devices 220 (shown in FIG. 2) and provided to the PD computer device 120 (shown in FIG. 1). The vectors 720, 725, and 730 can also be calculated by the PD computer device 120. In the exemplary embodiment, the PD computer device 120 uses the three vectors 720, 725, and 730 to determine a source location for the phenomena 105. Based on the three vectors 720, 725, and 730, the PD computer device 120 is able to determine the source of the phenomena 105 and then report that source location to the connected user devices 125 (shown in FIG. 1).

In some embodiments, when the island computer device 220 and/or the PD computer device 120 detects a valid signal 110 associated with a phenomena 105, the island computer device 220 and/or the PD computer device 120 will check the sensor information from the other sensors 115 in the island 705. When a valid signal 110 is detected and a valid vector 720 for the signal 110 is calculated, the PD computer device 120 can determine if other islands 710 and 715 in the area have detected the signal 110 to use that information to determine a location of the source of the phenomena 105. In some embodiments, the PD computer device 120 will determine an area where the phenomena 105 may be located based on differences in when the signals 110 reached the various islands and the materials in the ground between the source and each of the detecting islands 600. In some further embodiments, the PD computer device 120 determines a probability or confidence level for the location of the source of the phenomena 105.

In the exemplary embodiment, the PD computer device 120 accounts for the roundness of the Earth when calculating the intersection point of the vectors 720, 725, and 730. Furthermore, the Earth is not a perfect sphere, which the PD computer device 120 may consider.

In the exemplary embodiment, individual islands 600 can be between 300 kilometers (200 miles) to 700 km (500 miles) apart. Furthermore, with precise sensors 115, the islands 600 can detect signals 110 from phenomena 105 that occurs up to 1600 kilometers (1000 miles). In at least one embodiment, islands 600 can be positioned based on the signals 110 and phenomena 105 that they are configured to detect, both on relative location and ground materials and the effect that those materials will have on the signal 110.

While FIG. 7 uses three islands 705, 710, and 715 to detect the location of the source of the phenomena 105, ones having skill in the art that more or fewer islands 600 may be used to detect the location. In at least some embodiments, the more islands 600 used in the calculation, the higher the confidence level in the accuracy of the location.

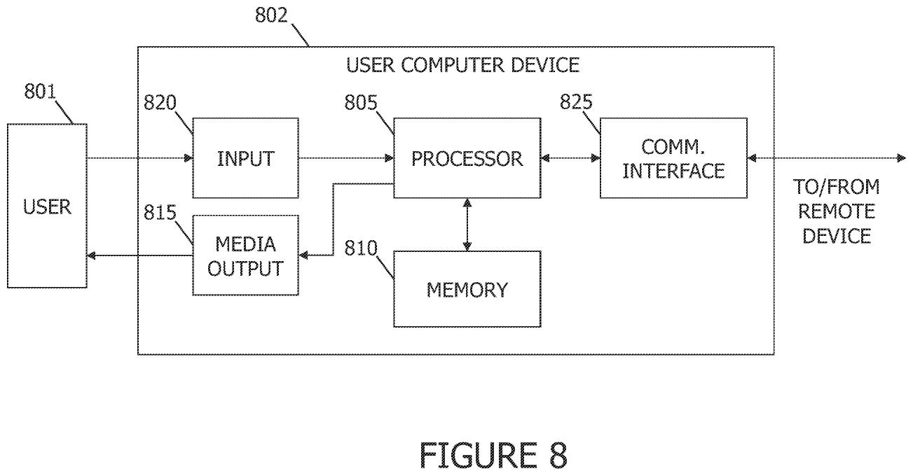

FIG. 8 illustrates an example configuration of a user computer device 802 used in the system 100 (shown in FIG. 1), in accordance with one example of the present disclosure. User computer device 802 is operated by a user 801. The user computer device 802 can include, but is not limited to, user device 125 (shown in FIG. 1), island computer device 220 (shown in FIG. 2), and station computer devices 305, 310, and 315 (all shown in FIG. 3). The user computer device 802 includes a processor 805 for executing instructions. In some examples, executable instructions are stored in a memory area 810. The processor 805 can include one or more processing units (e.g., in a multi-core configuration). The memory area 810 is any device allowing information such as executable instructions and/or transaction data to be stored and retrieved. The memory area 810 can include one or more computer-readable media.

The user computer device 802 also includes at least one media output component 815 for presenting information to the user 801. The media output component 815 is any component capable of conveying information to the user 801. In some examples, the media output component 815 includes an output adapter (not shown) such as a video adapter and/or an audio adapter. An output adapter is operatively coupled to the processor 805 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some examples, the media output component 815 is configured to present a graphical user interface (e.g., a web browser and/or a client application) to the user 801. A graphical user interface can include, for example, an interface for viewing the information about the detected phenomena 105 (shown in FIG. 1). In some examples, the user computer device 802 includes an input device 820 for receiving input from the user 801. The user 801 can use the input device 820 to, without limitation, select a sensor 115 (shown in FIG. 1) to view. The input device 820 can include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen can function as both an output device of the media output component 815 and the input device 820.

The user computer device 802 can also include a communication interface 825, communicatively coupled to a remote device such as the PD computer device 120 (shown in FIG. 1). The communication interface 825 can include, for example, a wired or wireless network adapter and/or a wireless data transceiver for use with a mobile telecommunications network.

Stored in the memory area 810 are, for example, computer-readable instructions for providing a user interface to the user 801 via the media output component 815 and, optionally, receiving and processing input from the input device 820. A user interface can include, among other possibilities, a web browser and/or a client application. Web browsers enable users, such as the user 801, to display and interact with media and other information typically embedded on a web page or a website from the PD computer device 120. For example, instructions can be stored by a cloud service, and the output of the execution of the instructions sent to the media output component 815.

The processor 805 executes computer-executable instructions for implementing aspects of the disclosure.

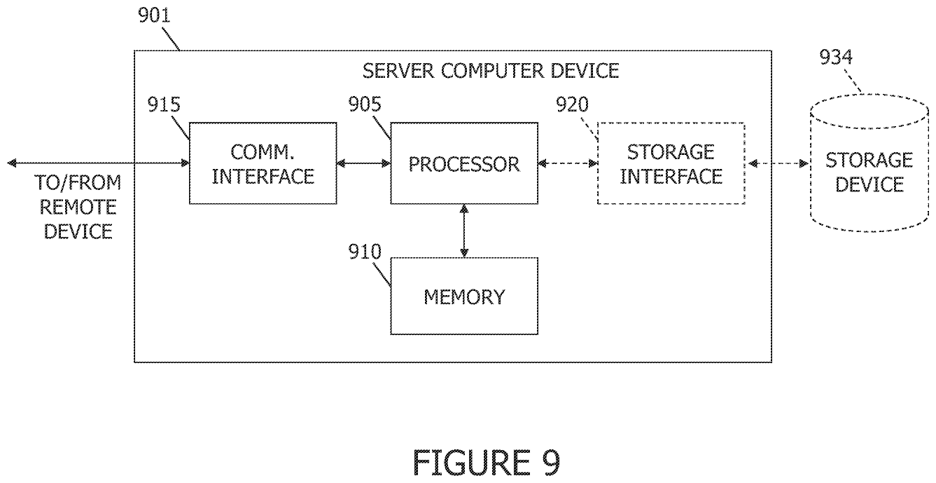

FIG. 9 illustrates an example configuration of a server computer device 901 used in the system 100 (shown in FIG. 1), in accordance with one example of the present disclosure. Server computer device 901 can include, but is not limited to, the PD computer device 120 (shown in FIG. 1), island computer device 220 (shown in FIG. 2), and station computer devices 305, 310, and 315 (all shown in FIG. 3). The server computer device 901 also includes a processor 905 for executing instructions. Instructions can be stored in a memory area 910. The processor 905 can include one or more processing units (e.g., in a multi-core configuration).

The processor 905 is operatively coupled to a communication interface 915 such that the server computer device 901 is capable of communicating with a remote device such as another server computer device 901, another PD computer device 120, another island computer device 220, one or more station computer devices 305, 310, and 315, or one or more user devices 125 (shown in FIG. 1). For example, the communication interface 915 can receive requests from the user device 125 via the Internet, as illustrated in FIG. 1.

The processor 905 can also be operatively coupled to a storage device 934. The storage device 934 is any computer-operated hardware suitable for storing and/or retrieving data, such as, but not limited to, data associated with the database. In some examples, the storage device 934 is integrated in the server computer device 901. For example, the server computer device 901 can include one or more hard disk drives as the storage device 934. In other examples, the storage device 934 is external to the server computer device 901 and can be accessed by a plurality of server computer devices 901. For example, the storage device 934 can include a storage area network (SAN), a network attached storage (NAS) system, and/or multiple storage units such as hard disks and/or solid-state disks in a redundant array of inexpensive disks (RAID) configuration.

In some examples, the processor 905 is operatively coupled to the storage device 934 via a storage interface 920. The storage interface 920 is any component capable of providing the processor 905 with access to the storage device 934. The storage interface 920 can include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 905 with access to the storage device 934.

The processor 905 executes computer-executable instructions for implementing aspects of the disclosure. In some examples, the processor 905 is transformed into a special purpose microprocessor by executing computer-executable instructions or by otherwise being programmed.

### Machine Learning & Other Matters

The computer-implemented methods discussed herein may include additional, less, or alternate actions, including those discussed elsewhere herein. The methods may be implemented via one or more local or remote processors, transceivers, servers, and/or sensors, and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

In some embodiments, the design system is configured to implement machine learning, such that the neural network “learns” to analyze, organize, and/or process data without being explicitly programmed. Machine learning may be implemented through machine learning (ML) methods and algorithms. In an exemplary embodiment, a machine learning (ML) module is configured to implement ML methods and algorithms. In some embodiments, ML methods and algorithms are applied to data inputs and generate machine learning (ML) outputs. Data inputs may include but are not limited to: analog and digital signals (e.g. sound, light, motion, natural phenomena, etc.) Data inputs may further include: sensor data, image data, video data, and telematics data. ML outputs may include but are not limited to: digital signals (e.g. information data converted from natural phenomena). ML outputs may further include: speech recognition, image or video recognition, medical diagnoses, statistical or financial models, processed signals, signal recognition and identification, autonomous vehicle decision-making models, robotics behavior modeling, signal detection, fraud detection analysis, user input recommendations and personalization, game AI, skill acquisition, targeted marketing, big data visualization, weather forecasting, and/or information extracted about a computer device, a user, a home, a vehicle, or a party of a transaction. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, recurrent neural networks, Monte Carlo search trees, generative adversarial networks, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, ML methods and algorithms are directed toward supervised learning, which involves identifying patterns in existing data to make predictions about subsequently received data. Specifically, ML methods and algorithms directed toward supervised learning are “trained” through training data, which includes example inputs and associated example outputs. Based on the training data, the ML methods and algorithms may generate a predictive function which maps outputs to inputs and utilize the predictive function to generate ML outputs based on data inputs. The example inputs and example outputs of the training data may include any of the data inputs or ML outputs described above. For example, a ML module may receive training data comprising data associated with different signals received and their corresponding classifications, generate a model which maps the signal data to the classification data, and recognize future signals and determine their corresponding categories.

In another embodiment, ML methods and algorithms are directed toward unsupervised learning, which involves finding meaningful relationships in unorganized data. Unlike supervised learning, unsupervised learning does not involve user-initiated training based on example inputs with associated outputs. Rather, in unsupervised learning, unlabeled data, which may be any combination of data inputs and/or ML outputs as described above, is organized according to an algorithm-determined relationship. In an exemplary embodiment, a ML module coupled to or in communication with the design system or integrated as a component of the design system receives unlabeled data comprising event data, financial data, social data, geographic data, cultural data, signal data, and political data, and the ML module employs an unsupervised learning method such as “clustering” to identify patterns and organize the unlabeled data into meaningful groups. The newly organized data may be used, for example, to extract further information about the potential classifications.

In yet another embodiment, ML methods and algorithms are directed toward reinforcement learning, which involves optimizing outputs based on feedback from a reward signal. Specifically ML methods and algorithms directed toward reinforcement learning may receive a user-defined reward signal definition, receive a data input, utilize a decision-making model to generate a ML output based on the data input, receive a reward signal based on the reward signal definition and the ML output, and alter the decision-making model so as to receive a stronger reward signal for subsequently generated ML outputs. The reward signal definition may be based on any of the data inputs or ML outputs described above. In an exemplary embodiment, a ML module implements reinforcement learning in a user recommendation application. The ML module may utilize a decision-making model to generate a ranked list of options based on user information received from the user and may further receive selection data based on a user selection of one of the ranked options. A reward signal may be generated based on comparing the selection data to the ranking of the selected option. The ML module may update the decision-making model such that subsequently generated rankings more accurately predict optimal constraints.

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein may include additional, less, or alternate functionality, including that discussed elsewhere herein. The computer systems discussed herein may include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose various implementations, including the best mode, and also to enable any person skilled in the art to practice the various implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
a plurality of seismic sensors; and
a computer device comprising at least one processor in communication with at least one memory device, wherein the computer device is further in communication with the plurality of seismic sensors, and wherein the at least one processor is programmed to:
store a plurality of distances between each of the plurality of seismic sensors;
store one or more fingerprints of a signal to be detected;
receive a first signal transmitted from a first seismic sensor of the plurality of seismic sensors, wherein the first signal was observed by the first seismic sensor at a first time;
receive the first signal transmitted from a second seismic sensor of the plurality of seismic sensors, wherein the first signal was observed by the second seismic sensor at a second time;
compare the first signal to the one or more fingerprints of the signal to be detected; and
determine a direction of travel of the first signal based on the distance between the first seismic sensor and the second seismic sensor, the first time, and the second time.

2. The system of claim 1, wherein the at least one processor is further programmed to:
receive the first signal transmitted from a third seismic sensor of the plurality of seismic sensors, wherein the first signal was observed by the third seismic sensor at a third time; and
determine a direction of travel of the first signal based on the distance between the first seismic sensor and the second seismic sensor, a distance between the first seismic sensor and the third seismic sensor, a distance between the second seismic sensor and the third seismic sensor, the first time, the second time, and the third time.

3. The system of claim 1, wherein the at least one processor is further programmed to:
receive a plurality of signals observed by the first seismic sensor;
compare the plurality of signals to the one or more fingerprints of a signal to be detected; and
detect the first signal based on the comparison.

4. The system of claim 1 further comprising a plurality of global positioning system (GPS) devices associated with the plurality of seismic sensors, wherein a first GPS device of the plurality of GPS devices is associated with the first seismic sensor, and wherein a second GPS device of the plurality of GPS devices is associated with the second seismic sensor.

5. The system of claim 4, wherein the at least one processor is further programmed to receive the first time from the first GPS device and the second time from the second GPS device.

6. The system of claim 4, wherein the distance between the first seismic sensor and the second seismic sensor is based on location data from the first GPS device and the second GPS device.

7. The system of claim 1, wherein the plurality of seismic sensors are buried underground.

8. The system of claim 1, wherein the plurality of seismic sensors are positioned over 100 meters from each other.

9. The system of claim 1, wherein the at least one processor is further programmed to transmit the determined direction of travel to a remote computer device.

10. The system of claim 1, wherein the computer device is an island computer device, and wherein the system further comprises a plurality of computer devices, wherein each computer device of the plurality of computer devices is associated with one of the plurality of seismic sensors, and wherein the plurality of computer devices are programmed to transfer sensor information from their corresponding seismic sensor to the island computer device.

11. The system of claim 1, wherein the signal is a pressure wave.

12. The system of claim 1, wherein the signal is one of an electromagnetic pulse, a traveling wave, a vibration, or a sound frequency.

13. The system of claim 1, wherein the signal is generated by a man-made phenomenon.

14. The system of claim 1, wherein the signal is generated by a natural phenomenon.

15. A system comprising:
a plurality of islands, wherein each island of the plurality of islands includes a plurality of seismic sensors and an island computer device, wherein the island computer device is in communication with the plurality of seismic sensors associated within the island; and
a computer device comprising at least one processor in communication with at least one memory device, wherein the computer device is further in communication with the plurality of island computer devices, and wherein the at least one processor is programmed to:
receive from a first island computer device of the plurality of island computer devices a first direction of travel of a first signal detected by the plurality of seismic sensors of a first island of the plurality of islands;
receive from a second island computer device of the plurality of island computer devices a second direction of travel of a second signal detected by the plurality of seismic sensors of a second island of the plurality of islands;
determine a source location of the first signal based on the first direction of travel and the second direction of travel; and
report the source location to a remote computer device.

16. The system of claim 15, wherein the at least one processor is further programmed to:
receive from a third island computer device of the plurality of island computer devices a third direction of travel of the first signal detected by the plurality of seismic sensors of a third island of the plurality of islands; and
determine the source location of the first signal based on the first direction of travel, the second direction of travel, and the third direction of travel.

17. The system of claim 15, wherein the at least one processor is further programmed to calculate a confidence level for the source location.

18. The system of claim 15, wherein the at least one processor is further programmed to:
store a plurality of fingerprints for a plurality of signals to detect including the first signal;
receive a plurality of signals from the first island computer device, wherein the plurality of signals are detected by the plurality of seismic sensors of the first island;
compare the plurality of signals to the plurality of fingerprints; and
detect the first signal based on the comparison.

19. The system of claim 18, wherein the at least one processor is further programmed to determine a direction of travel of the first signal based on attributes of the plurality of seismic sensors in the first island.

20. The system of claim 15, wherein the first signal is one of a pressure wave, an electromagnetic pulse, a traveling wave, a vibration, or a sound frequency.
